(19) United States
(12) Patent Application Publication
(10) Pub. No.: US 2025/0222907 A1
(43) Pub. Date: Jul. 10, 2025

(54) BRAKE DEVICE FOR VEHICLE

(71) Applicant: DENSO CORPORATION, Kariya-city (JP)

(72) Inventor: YUSUKE SHIBATA, Kariya-city (JP)

(21) Appl. No.: 19/065,818

(22) Filed: Feb. 27, 2025

Related U.S. Application Data
(63) Continuation of application No. PCT/JP2023/029671, filed on Aug. 17, 2023.

(30) Foreign Application Priority Data
Sep. 1, 2022 (JP) 2022-139285

(51) Int. Cl. B60T 8/172; B60T 1/06; B60T 8/171; B60T 13/74; H02P 3/04

(52) U.S. Cl. CPC B60T 8/172; B60T 1/065; B60T 8/171; B60T 13/746; H02P 3/04; B60T 2220/04

(57) ABSTRACT

A torque command calculation unit calculates a torque command value for a motor based on a required braking force commanded from an external source. A relationship between a motor torque and braking forces generated in the electric brakes has a hysteresis characteristic. When the torque increases, the braking force increases along a positive efficiency line, and when the torque decreases, the braking force decreases along an inverse efficiency line. A specific controller calculates a torque command value to bring an actual load closer to a load command value or to bring an actual position closer to a position command value. A control adjuster adjusts a parameter of a control calculation of the specific controller, or a parameter of a control calculation on an input side or on output side of the specific controller during increase operation, during decrease operation, or during transition between the increase operation and the decrease operation.

### CROSS REFERENCE TO RELATED APPLICATIONS

This application is a continuation application of International Patent Application No. PCT/JP2023/029671 filed on Aug. 17, 2023, which designated the U.S. and based on and claims the benefits of priority of Japanese Patent Application No. 2022-139285 filed on Sep. 1, 2022. The entire disclosure of all of the above applications is incorporated herein by reference.

### TECHNICAL FIELD

The present disclosure relates to a brake device for vehicle.

### BACKGROUND

Conventionally, in an electric brake device for a vehicle in which a relationship between a motor torque and a pressing force applied to a brake disc from a motion conversion mechanism has a hysteresis characteristic, a technique is known for controlling a drive of the motor so that a magnitude of the pressing force reaches a target value.

### SUMMARY

An object of the present disclosure is to provide a brake device for vehicle that is capable of appropriately controlling an electric brake having a hysteresis characteristic in response to switching between increasing and decreasing the braking force.

The brake device for vehicle in the present disclosure is mounted on a vehicle in which multiple electric brakes are provided on each wheel, and convert the torque output by a motor into a linear force by a linear mechanism and generate the braking force pressed against the corresponding wheel.

The brake device for vehicle includes a braking force control unit that has a torque command calculation unit and a current command calculation unit and controls the braking force generated by each electric brake. The torque command calculation unit calculates a torque command value for the motor based on a required braking force commanded from an external source. The current command calculation unit calculates a current command value for supplying current to the motor based on the torque command value.

The electric brake includes a load sensor configured to detect an actual load which is a braking load actually applied to the wheel, or a position sensor configured to detect an actual position which is an actual rotation angle of the motor or an actual stroke of the linear motion mechanism.

A relationship between the torque of the motor and the braking force generated by the electric brake has a hysteresis characteristics in which, as the torque increases, the braking force increases along a positive efficiency line, as the torque decreases from a turning value where the torque changes from increasing to decreasing to a holding critical value, the braking force is maintained constant, and as the torque decreases from the holding critical value, the braking force decreases along the inverse efficiency line.

An operation that increases the torque of the motor along the positive efficiency line is defined as an “increase operation”, an operation that holds the braking force at any operating point between the positive efficiency line and the inverse efficiency line is defined as a “hold operation”, and an operation that decreases the torque of the motor along the inverse efficiency line is defined as a “decrease operation”.

In a first aspect of the present disclosure, the torque command calculation unit includes a specific controller and a control adjuster. The specific controller calculates the torque command value so that the actual load detected by the load sensor approaches a load command value, or the actual position detected by the parameter of a control calculation of the specific controller, or on an input side or output side of the specific controller during the increase operation, the decrease operation, or during a transition between the increase operation and the decrease operation.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram illustrating a configuration of a vehicle with which a vehicle brake device related to each embodiment is equipped;

FIG. 2 is a block diagram of a braking force control of an electric brake corresponding to each wheel;

FIG. 3A is a schematic diagram of an electric brake pad;

FIG. 3B is a characteristic diagram of a pad load and a pad position;

FIG. 4 is a diagram showing hysteresis characteristics of a motor torque and a braking force;

FIG. 5 is a block diagram of a torque command calculation unit and a current command calculation unit according to a first embodiment;

FIG. 6 is a diagram for explaining calculation of maximum torque and minimum torque;

FIG. 7 is a diagram showing a change in a feedforward term during a decreasing operation to an increasing operation transition;

FIG. 8 is a flowchart of an adjustment process for a feedforward term;

FIG. 9 is a block diagram of a torque command calculation unit according to a second embodiment;

FIG. 10 is a flowchart of a gain adjustment process;

FIG. 11 is a diagram of a comparative example for a combined embodiment of the first and second embodiments;

FIG. 12 is a diagram for explaining the effect of the combined embodiment of the first and second embodiments;

FIG. 13 is a block diagram of a torque command calculation unit according to a third embodiment;

FIG. 14 is a diagram showing a dead zone setting according to a basic example of the third embodiment;

FIG. 15A is a diagram showing positive and negative symmetric dead zone settings according to another example of the third embodiment;

FIG. 15B is a diagram showing positive and negative asymmetric dead zone setting according to another example of the third embodiment;

FIG. 16 is a flowchart of a dead zone adjustment process;

FIG. 17 is a diagram of a comparative example for the third embodiment;

FIG. 18 is a diagram for explaining the effect of the third embodiment; and

FIG. 19 is a block diagram of a torque command calculation unit according to a fourth embodiment.

### DETAILED DESCRIPTION

In an assumable example of an electric brake device for a vehicle in which a relationship between a motor torque and a pressing force applied to a brake disc from a motion conversion mechanism has a hysteresis characteristic, a technique is known for controlling a drive of the motor so that a magnitude of the pressing force reaches a target value. For example, in the electric brake device, a motor control device controls a drive current of the motor based on the magnitude of the pressing force detected by a load sensor. The relationship between the motor torque and the pressing force has a hysteresis characteristic. When the pressing force is applied to and maintained on the brake disc, this motor control device increases the motor torque along a positive efficiency line until the pressing force rises to a predetermined value greater than a target value, and then decreases the motor torque along an inverse efficiency line until the pressing force decreases to the target value.

In this specification, a vertical axis of a hysteresis diagram is described as “correlation amount of braking force”. The pressing force detected by a load sensor corresponds to an actual braking force, which is a braking force actually output by an electric brake. Moreover, a load command value corresponds to a required braking force. In the conventional technology, an operating point is shifted from the positive efficiency line to the inverse efficiency line to maintain the braking force, thereby making it possible to reduce the current that drives the motor while the braking force is being maintained.

When controlling an electric brake with hysteresis characteristics, larger torque changes are required when transitioning from increasing to decreasing the braking force, and when transitioning from decreasing to increasing the braking force, compared to controlling the electric brake without hysteresis characteristic, which may result in delayed response. Furthermore, when a control gain of a PI controller is set equal for the increasing operation and the decreasing operation, there is a risk of overshoot occurring during the decreasing operation. Furthermore, unnecessary switching between increasing and decreasing the braking force occurs due to crossing the braking force target value, which may result in torque pulsation.

An object of the present disclosure is to provide a brake device for vehicle that is capable of appropriately controlling an electric brake having a hysteresis characteristic in response to switching between increasing and decreasing the braking force.

The brake device for vehicle in the present disclosure is mounted on a vehicle in which multiple electric brakes are provided on each wheel, and convert the torque output by a motor into a linear force by a linear mechanism and generate the braking force pressed against the corresponding wheel.

The brake device for vehicle includes a braking force control unit that has a torque command calculation unit and a current command calculation unit and controls the braking force generated by each electric brake. The torque command calculation unit calculates a torque command value for the motor based on a required braking force commanded from an external source. The current command calculation unit calculates a current command value for supplying current to the motor based on the torque command value.

The electric brake includes a load sensor configured to detect an actual load which is a braking load actually applied to the wheel, or a position sensor configured to detect an actual position which is an actual rotation angle of the motor or an actual stroke of the linear motion mechanism.

A relationship between the torque of the motor and the braking force generated by the electric brake has a hysteresis characteristics in which, as the torque increases, the braking force increases along a positive efficiency line, as the torque decreases from a turning value where the torque changes from increasing to decreasing to a holding critical value, the braking force is maintained constant, and as the torque decreases from the holding critical value, the braking force decreases along the inverse efficiency line.

An operation that increases the torque of the motor along the positive efficiency line is defined as an “increase operation”, an operation that holds the braking force at any operating point between the positive efficiency line and the inverse efficiency line is defined as a “hold operation”, and an operation that decreases the torque of the motor along the inverse efficiency line is defined as a “decrease operation”.

In a first aspect of the present disclosure, the torque command calculation unit includes a specific controller and a control adjuster. The specific controller calculates the torque command value so that the actual load detected by the load sensor approaches a load command value, or the actual position detected by the parameter of a control calculation of the specific controller, or a parameter of a control calculation on an input side or on output side of the specific controller during the increase operation, during the decrease operation, or during a transition between the increase operation and the decrease operation.

In the first aspect of the present disclosure, in controlling an electric brake having a hysteresis characteristic, the control can be appropriately performed by adjusting the parameters of the control calculation in response to switching between the increase operation and decrease operation of the braking force.

In a second aspect of the present disclosure, the torque command calculation unit has a specific controller and a dead zone setter. The specific controller calculates the torque command value so that the actual load detected by the load sensor approaches a load command value, or the actual position detected by the position sensor approaches a position command value. a dead zone setter that sets a predetermined range as a dead zone so that when a load deviation, which is a deviation between the load command value input to the specific controller and the actual load, or a position deviation, which is a deviation between the position command value and the actual position, is within the predetermined range including zero, the load deviation or the position deviation is regarded as zero.

In the second aspect of the present disclosure, by setting the dead zone, it is possible to prevent unnecessary switching between the increase operation and the decrease operation.

Hereinafter, a brake device for a vehicle according to several embodiments of the present disclosure will be described with reference to the drawings. In the multiple embodiments, substantially the same components are denoted by the same reference numerals, and a description of the same components will be omitted. The following first to fourth embodiments are collectively referred to as “present embodiment”. The brake device for vehicle in the present embodiments is mounted on a vehicle in which multiple electric brakes are provided on each wheel, and convert the torque output by a motor into a linear force by a linear mechanism and generate the braking force pressed against the corresponding wheel. The brake device for the vehicle includes a braking force control unit that controls a braking force generated by each of the electric brakes.

### Vehicle Configuration:

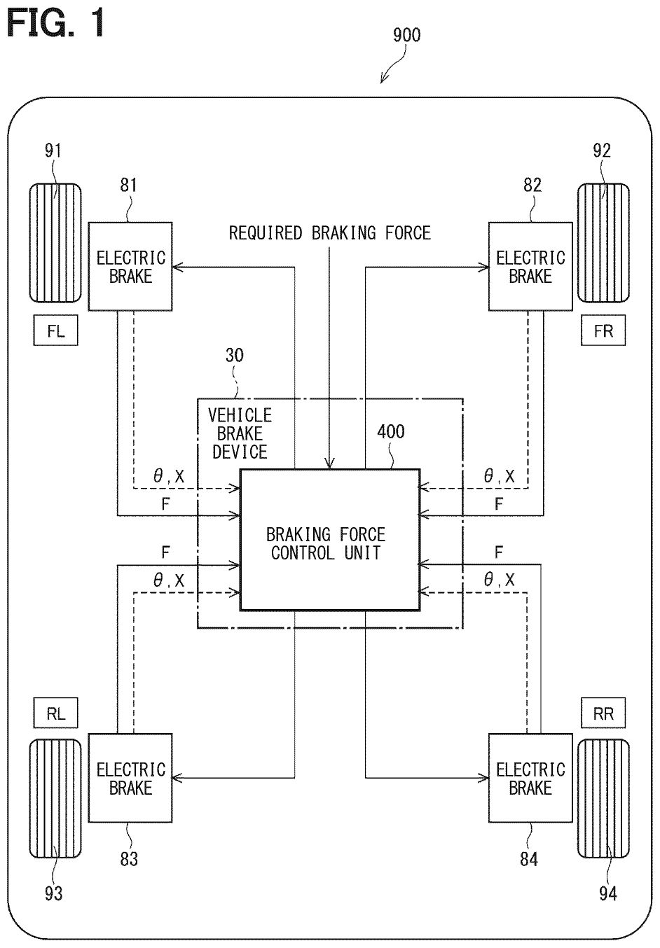

The configurations of a vehicle 900 on which the brake device 30 for the vehicle of the present embodiment is mounted and electric brakes 81 to 84 will be described with reference to FIGS. 1 to 3B. As shown in FIG. 1, the vehicle 900 is a four-wheel vehicle having two rows of left and right pairs of wheels 91, 92, 93, 94 in a front-rear direction. The left and right wheels 91, 92 at the front row may also be noted as “FL” and “FR”, respectively. The left and right wheels 93, 94 at the rear row may also be noted as “RL” and “RR”, respectively. The electric brakes 81, 82, 83, 84 are provided for the respective wheels 91, 92, 93, 94. In other words, four electric brakes are provided in this example. Hereinafter, four consecutive reference numerals will be appropriately abbreviated to “wheels 91 to 94” and “electric brakes 81 to 84” in some occasions.

The vehicle brake device 30 includes a braking force control unit 400. The braking force control unit 400 controls the braking forces generated by the electric brakes 81 to 84 based on a required braking force commanded from an outside. The required braking force is commanded by the driver's brake operation, a braking signal from a driving support device, or the like. A load sensor signal F (solid line) detecting a pressure load on the brake pad, or position sensor signals θ, X (dashed lines) detecting an operating position of the motor or linear motion mechanism are input from each electric brake 81 to 84 to the braking force control unit 400.

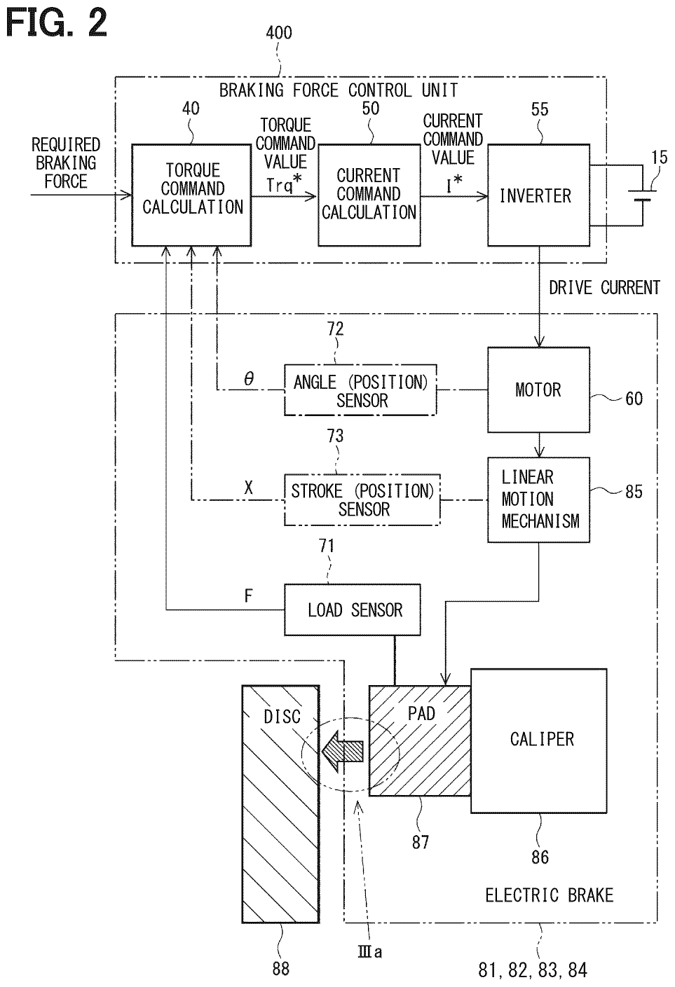

In the present embodiment, the control configurations of the electric brakes 81 to 84 are the same. FIG. 2 illustrates the control configuration of the electric brakes by the braking force control unit 400, taking any one of the electric brakes 81 to 84 as an example.

Each of the electric brakes 81 to 84 includes a motor 60, a linear motion mechanism 85, and a caliper 86. The motor 60 is, for example, a permanent magnet type three-phase brushless motor, and outputs torque in response to a drive current supplied from the braking force control unit 400. The linear motion mechanism 85 is an actuator that converts the output rotation of the motor 60 into linear motion while decelerating the output rotation. The rotation angle θ of the motor 60 and the stroke X of the linear motion mechanism 85 are proportional to each other. In this manner, each of the electric brakes 81 to 84 converts the torque output by the motor 60 into linear force by the linear motion mechanism 85, and generates a braking force to press against the corresponding wheel 91 to 94.

The output torque of the motor 60 operates a pad 87 of a caliper 86 via the linear motion mechanism 85. The pad 87 moves and presses against the disks 88 of each wheel 91 to 94 to generate a braking force through friction. Furthermore, the pad 87 separates from the disk 88, and the braking force is released.

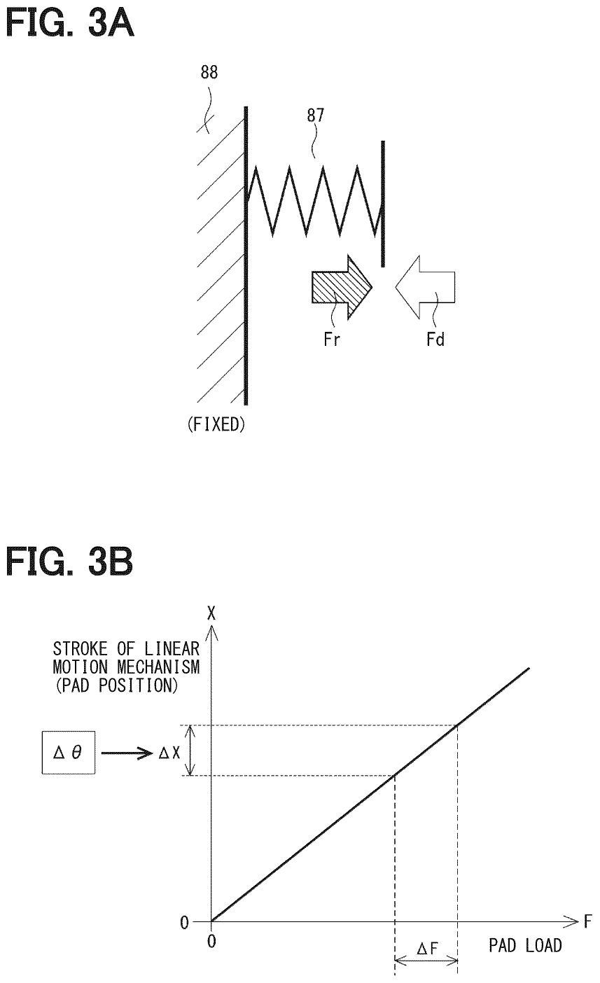

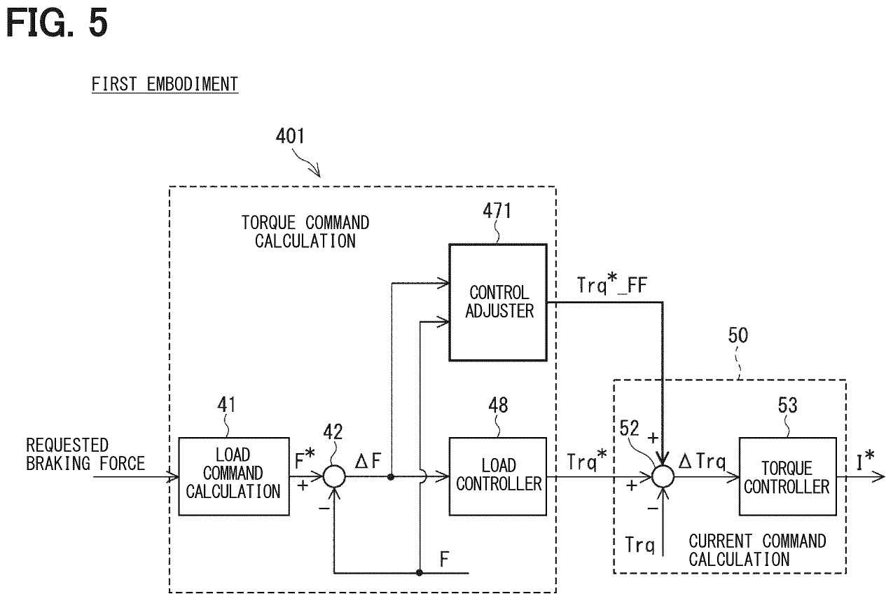

With reference to FIGS. 3A and 3B, the characteristics of the pad 87 of the electric brakes 81 to 81 shown in a portion IIIa of FIG. 2 will be supplemented. As shown in FIG. 3A, the pad 87 has spring-like characteristics, and a pressing force Fd by the linear motion mechanism 85 and a reaction force Fr according to the amount of deformation act in opposite directions. As shown in FIG. 3B, a pad position X based on the stroke of the linear motion mechanism 85 and a pad load F are approximately proportional. When the pad position changes by ΔX due to a change 40 in the rotation angle of the motor 60, the pad load changes by ΔF. A symbol “ΔF” indicates the change in load only in FIG. 3B. The symbol “ΔF” has a different meaning from “ΔF” used in FIG. 5 and subsequent figures, which indicates a load deviation between the load command value and the actual load.

Returning to FIG. 2, the braking force control unit 400 includes a torque command calculation unit 40, a current command calculation unit 50, and an inverter 55. The torque command calculation unit 40 calculates a torque command value Trq* of the motor 60 based on a required braking force commanded from an external source. The current command calculation unit 50 calculates a current command value I* to be supplied to the motor 60 based on the torque command value.

The inverter 55 converts the DC power of the battery 15 into AC power, and supplies the AC power according to the current command value I* to the motor 60. A detailed configuration such as current feedback from the current command calculation unit 50 to the inverter 55 is omitted. According to a general motor control technique, for example, the inverter 55 performs a switching operation in accordance with a switching signal by PWM control.

In the basic embodiment, the electric brakes 81 to 84 are provided with a load sensor 71 that detects an actual load F, which is the braking load actually applied to the wheels 91 to 94. The actual load F detected by the load sensor 71 is input to the torque command calculation unit 40. The torque command calculation unit 40 has a load controller that calculates a torque command value Trq* so as to bring the actual load F closer to a load command value calculated based on the required braking force. In the explanation of the first to fourth embodiments, it is assumed that the torque command calculation unit 40 performs the load control using the load controller.

However, in other embodiments, the electric brakes 81 to 84 may be equipped with an angle sensor 72 shown by a dashed line or a stroke sensor 73 shown by a dashed double-dashed line. The angle sensor 72 detects an actual angle θ, which is an actual rotation angle of the motor 60. The stroke sensor 73 detects an actual stroke X, which is the actual stroke of the linear motion mechanism 85.

The angle sensor 72 and the stroke sensor 73 are collectively referred to as the “position sensor”, and the actual angle θ and the actual stroke X are collectively referred to as the “actual position”. The actual positions θ, X detected by the position sensors 72, 73 are input to the torque command calculation unit 40. The torque command calculation unit 40 may have a position controller that calculates a torque command value Trq* so as to bring the actual positions θ, X closer to the position command value calculated based on the required braking force. In this specification, the load controller or the position controller is defined as a “specific controller.” In the torque command calculation unit of the first to fourth embodiments, the load controller 48 is used as the “specific controller”.

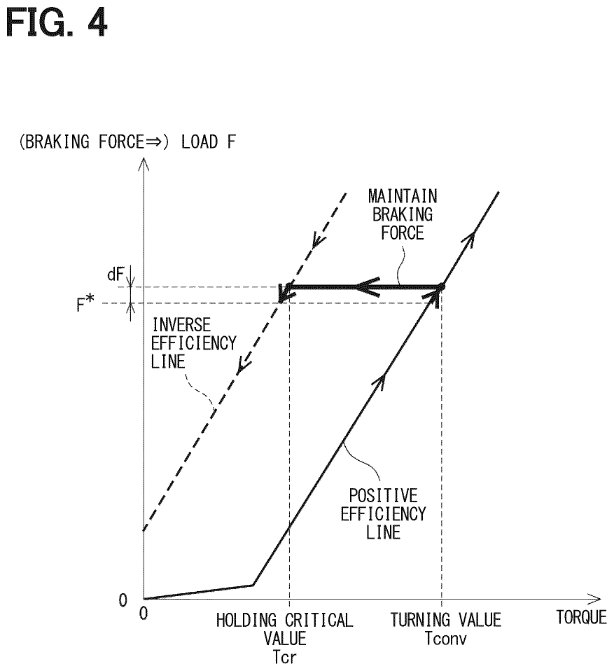

Next, the relationship between the motor torque and the braking force in the electric brake having this configuration will be described with reference to FIG. 4. The braking force is related to the brake pad load. Hereinafter, the term “torque” simply means the torque output by the motor 60, and the term “load” simply means the pressure load applied by the pad 87.

A relationship between the torque of the motor 60 and the braking forces generated in the electric brakes 81 to 84 has a hysteresis characteristic. When the torque increases, the braking force increases along the positive efficiency line. When the torque decreases from a turning value Tconv, where the torque changes from increasing to decreasing, to a holding critical value Tcr, the braking force is held constant. When the torque decreases from the holding critical value Tcr, the braking force decreases along the inverse efficiency line.

In the conventional technology, the torque of the motor is increased until the magnitude of the load detected by the load sensor reaches “a value that is greater than the target value F* by a predetermined offset value dF”. Thereafter, the drive current of the motor is controlled so as to reduce the motor torque until the magnitude of the load detected by the load sensor reaches the target value F*. In the process of reducing the torque of the motor, the load F, i.e., the braking force, is held.

An operation that increases the torque and braking force along the positive efficiency line is defined as an “increase operation”, an operation that holds the braking force at any operating point between the positive efficiency line and the inverse efficiency line is defined as a “hold operation”, and an operation that decreases the torque and braking force along the inverse efficiency line is defined as a “decrease operation”.

When controlling an electric brake with hysteresis characteristics, larger torque changes are required when transitioning from increasing to decreasing the braking force, and when transitioning from decreasing to increasing the braking force, compared to controlling the electric brake without hysteresis characteristic, which may result in delayed response. Furthermore, when a control gain of a PI controller is set equal for the increasing operation and the decreasing operation, there is a risk of overshoot occurring during the decreasing operation. Furthermore, unnecessary switching between increasing and decreasing the braking force occurs due to crossing the braking force target value, which may result in torque pulsation.

Therefore, the vehicle brake device 30 of the present embodiment aims to appropriately perform control associated with switching between increasing and decreasing the braking force in control of an electric brake having a hysteresis characteristic. The means for solving this problem are roughly divided into a group of the first to third embodiments and a fourth embodiment.

The torque command calculation unit 40 of the first to third embodiments has a “control adjuster” that adjusts parameters of the control calculation of the load controller, or on the input or output side of the load controller during the increase operation, during the decrease operation, or during a transition between the increase operation and the decrease operation. Next, a detailed configuration of each embodiment will be described. The reference numerals of the torque command calculation unit and the control adjuster in the first to third embodiments are “40” and “47”, respectively, followed by the third digit indicating a number of each embodiment.

In the torque command calculation unit 401 of the first embodiment, the control adjuster 471 adjusts a feedforward term of the torque command value Trq* as a parameter of the control calculation on the output side of the load controller during a transition between the increase operation and the decrease operation.

In the torque command calculation unit 402 of the second embodiment, the control adjuster 472 adjusts the control gain as a parameter of the control calculation of the load controller during the increase operation and during the decrease operation.

In the torque command calculation unit 403 of the third embodiment, the control adjuster 473 adjusts the upper and lower limit values of the dead band as parameters of the control calculation on the input side of the load controller during the increase operation and the decrease operation.

### First Embodiment

The first embodiment will be described with reference to FIGS. 5 to 8. As shown in FIG. 5, the torque command calculation unit 401 of the first embodiment has a control adjuster 471 in addition to a load command calculation unit 41, a load deviation calculator 42, and the load controller 48. In addition, the current command calculation unit 50 has a torque deviation calculator 52 and a torque controller 53.

The load command calculation unit 41 calculates a load command value F* based on the required braking force. The load deviation calculator 42 calculates a load deviation ΔF (=F*−F) between the actual load F detected by the load sensor 71 and the load command value F*, and outputs the load deviation ΔF to the load controller 48. The load controller 48 calculates the torque command value Trq* so as to bring the load deviation ΔF closer to zero, that is, so as to bring the actual load F closer to the load command value F*.

The control adjuster 471 calculates a hysteresis width W_hys in a torque-braking force map, as described below. Furthermore, the control adjuster 471 sets a feedforward term Trq*_FF of the torque command value, and outputs it to the torque deviation calculator 52 of the current command calculation unit 50. Hereinafter, the feedforward term Trq*_FF of the torque command value will be simply referred to as “feedforward term Trq*_FF.”

The control adjuster 471 acquires the actual load F and the load deviation ΔF, and estimates the current operating point on the map and the direction in which the braking force will increase and decrease. Then, the control adjuster 471 determines whether it is a transition from the increase operation to the decrease operation, or a transition from the decrease operation to the increase operation, and adjusts the feedforward term Trq*_FF.

The torque deviation calculator 52 of the current command calculation unit 50 receives as input the torque command value Trq* calculated by the load controller 48, the feedforward term Trq*_FF set by the control adjuster 471, and the actual torque Trq, which is the torque actually output by the motor 60. For example, in a permanent magnet type three-phase brushless motor, the actual torque Trq of the motor 60 is estimated from the d-axis current and the q-axis current using the number of pole pairs, the magnet flux, the d-axis inductance, and the q-axis inductance. Alternatively, the actual torque Trq of the motor 60 may be detected by a torque sensor.

The torque deviation calculator 52 calculates a value obtained by subtracting the actual torque Trq of the motor 60 from the sum of the torque command value Trq* and the feedforward term Trq*_FF as the torque deviation ΔTrq (=Trq*+Trq*_FF−Trq). The torque controller 53 calculates the current command value I* so that the torque deviation ΔTrq approaches zero, that is, so that the actual torque Trq approaches the sum of the torque command value Trq and the feedforward term Trq*_FF.

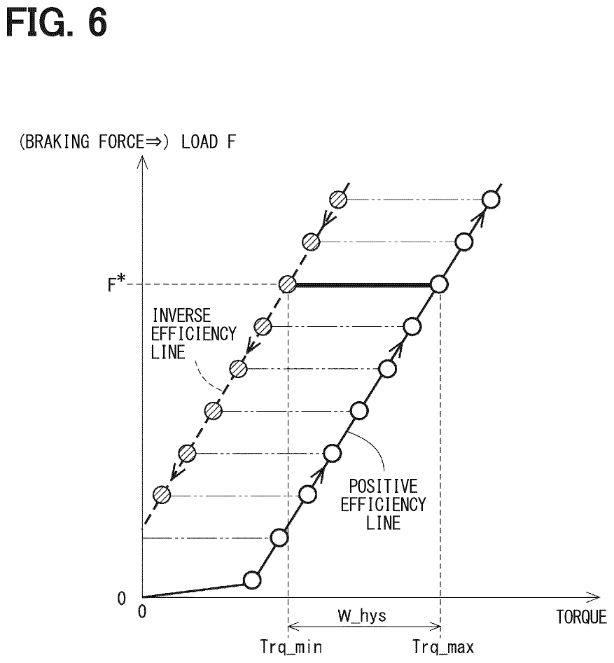

A storage of the maximum torque Trq_max and the minimum torque Trq_min and the calculation of the hysteresis width W_hys by the control adjuster 471 will be described with reference to FIG. 6. In the torque-braking force map of FIG. 6, a white circle on the positive efficiency line indicates maximum torque Trq_max, and a hatched circle on the inverse efficiency line indicates minimum torque Trq_min. The control adjuster 471 stores the maximum torque Trq_max and the minimum torque Trq_min corresponding to each load command value F*. Furthermore, the control adjuster 471 calculates a “hysteresis width W_hys” which is the difference between the maximum torque Trq_max and the minimum torque Trq_min.

For example, during the manufacturing process or at the time of an initial operation, the control adjuster 471 changes the torque with respect to the load command value F*, such as “from 0 to maximum torque and from maximum torque to 0” and stores the maximum torque Trq_max and the minimum torque Trq_min. The map may be updated appropriately each time the power is turned on, each time work is performed, etc. In addition, when performing the hold operation in which an excess operation is performed on the load command value F* and then a return operation is performed, as in the conventional technology, the control adjuster 471 may store the torque values at the start of the excess operation and at the end of the return operation. In this case, it is efficient to not have to maintain the entire map.

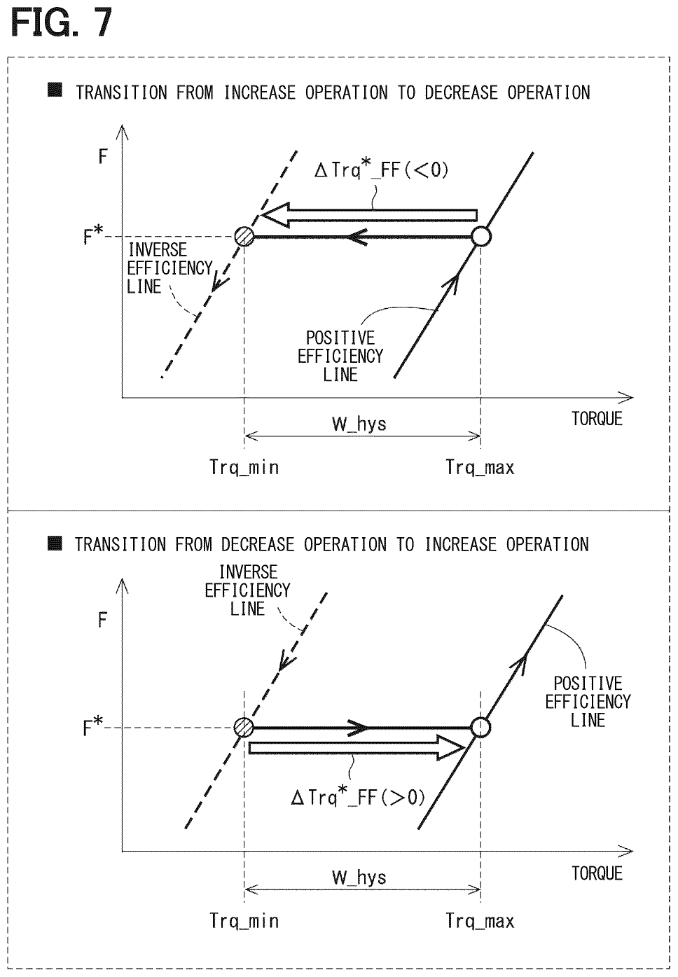

Next, an adjustment of the feedforward term Trq*_FF according to the transition direction between the increase operation and the decrease operation will be described with reference to FIG. 7. The control adjuster 471 sets the absolute value |ΔTrq*_FF| of the amount of change in the feedforward term to be equal to or smaller than the hysteresis width W_hys. The absolute value |ΔTrq*_FF| of the amount of change in the feedforward term is set so as not to exceed the hysteresis width W_hys, and a length of the block arrow indicating the amount of change in the feedforward term is illustrated as being slightly shorter than the hysteresis width W_hys.

When transitioning from the increase operation to the decrease operation, the control adjuster 471 decreases the value of the Trq feedforward term Trq*_FF. In other words, the amount of change ΔTrq*_FF obtained by subtracting the value before the change from the value after the change of the feedforward term becomes negative. When transitioning from the decrease operation to the increase operation, the control adjuster 471 increases the value of the Trq feedforward term Trq*_FF. In other words, the change amount ΔTrq*_FF of the feedforward term becomes positive.

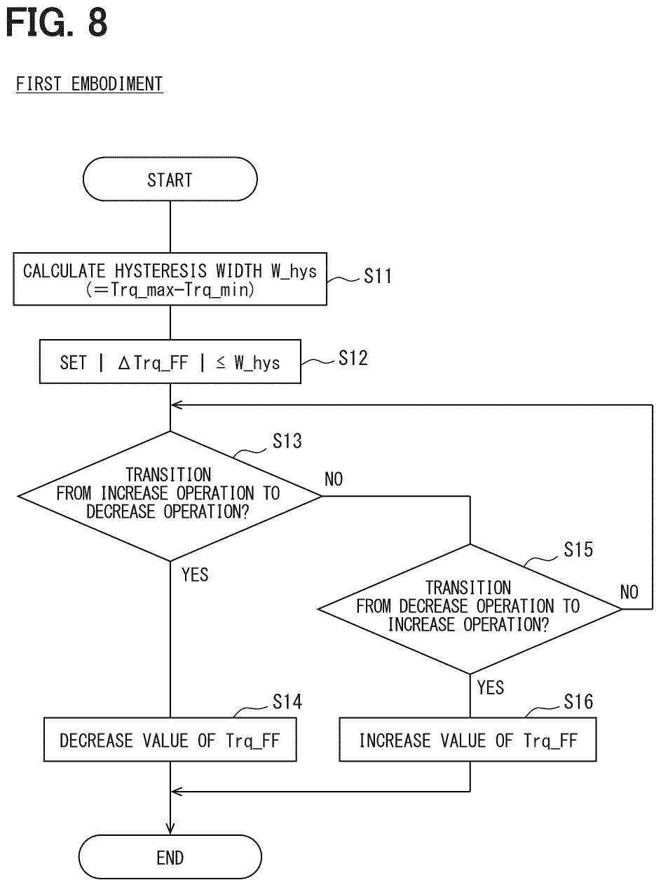

The feedforward term adjustment process executed by the control adjuster 471 will be described with reference to the flowchart of FIG. 8. In the following flowchart, a symbol S indicates a step.

In S11, the control adjuster 471 stores the maximum torque Trq_max and the minimum torque Trq_min corresponding to the held braking force, and calculates a hysteresis width W_hys which is the difference between the maximum torque Trq_max and the minimum torque Trq_min. In S12, the control adjuster 471 sets the absolute value |ΔTrq*_FF| of the amount of change in the feedforward term at the time of transition between the increase operation and the decrease operation to be equal to or less than the hysteresis width W_hys.

In S13, it is determined whether or not a transition from the increase operation to the decrease operation has occurred. When YES is confirmed in S13, then in S14, the control adjuster 471 decreases the value of feedforward term Trq*_FF. In S15, it is determined whether or not a transition from the decrease operation to the increase operation has occurred. When YES is confirmed in S15, then in S16, the control adjuster 471 increases the value of the feedforward term Trq*_FF.

In addition, in a modified example of the first embodiment, including a case where the hysteresis width W_hys is not calculated, the absolute value of the change amount of the feedforward term |ΔTrq*_FF| may be set to, for example, a fixed value regardless of the hysteresis width W_hys. In this case, steps S11 and S12 in the flowchart are not carried out.

In the first embodiment, when transitioning between the increase operation and the decrease operation, the value of the feedforward term Trq*_FF is increased and decreased depending on the transition direction, thereby making it possible to reduce a response delay associated with switching of operations. Moreover, by setting the absolute value of the change amount of the feedforward term |ΔTrq*_FF| to be equal to or less than the hysteresis width W_hys, it is possible to prevent an inappropriate torque command value Trq* from being calculated due to excessive adjustment. In particular, by setting the absolute value of the amount of change in the feedforward term |ΔTrq*_FF| equal to the hysteresis width W_hys, the response delay associated with switching of operations can be reduced to almost zero.

### Second Embodiment

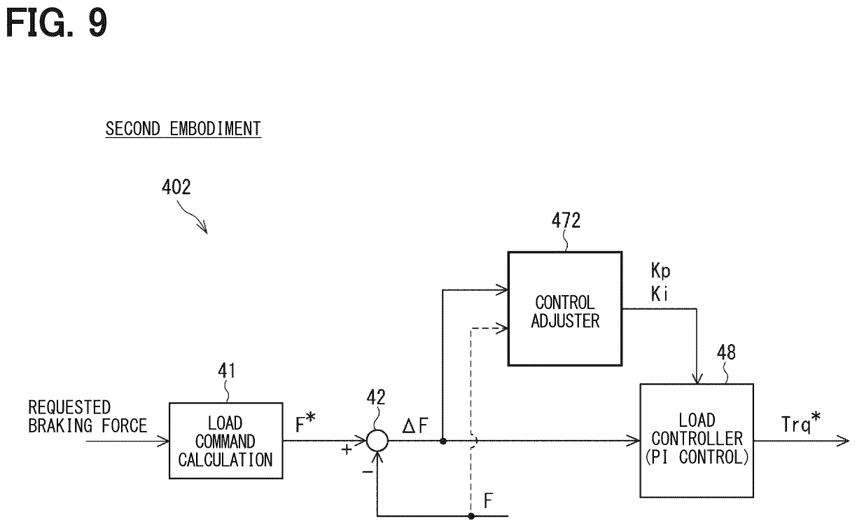

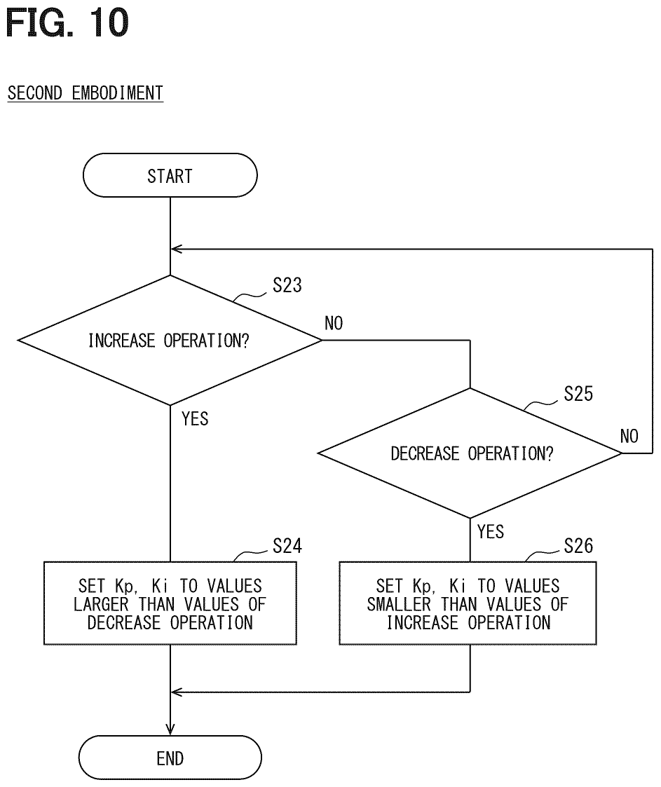

A second embodiment will be described with reference to FIGS. 9 and 10. As shown in FIG. 9, the torque command calculation unit 402 of the second embodiment has a control adjuster 472 in addition to the load command calculation unit 41, the load deviation calculator 42, and the load controller 48. Moreover, the load controller 48 of the second embodiment calculates the torque command value Trq* by a control calculation including a proportional-integral control (hereinafter, “PI control”). For example, the specific controller 48 may perform PID control, which includes a derivative control.

The control adjuster 472 acquires the load deviation ΔF and estimates the direction of increasing and decreasing in the braking force based on the positive and negative state of the load deviation ΔF. That is, the control adjuster 472 determines whether the current operation is the increase operation, the decrease operation, or the hold operation. Additionally, the control adjuster 472 may obtain the actual load F and estimate the current operating point on the map.

When the gradient of the positive efficiency line and the gradient of the inverse efficiency line differ in the map of FIG. 4, there is a possibility that optimal control performance cannot be obtained when common control gains Kp, Ki are used. Therefore, the control adjuster 472 modifies at least one of the proportional gain Kp or the integral gain Ki of the load controller 48 in both the increase and decrease operations. Preferably, the control adjuster 472 makes the proportional gain Kp and integral gain Ki of the load controller 48 larger in the increase operation than in the decrease operation.

The control adjuster 472 does not necessarily change both the proportional gain Kp and the integral gain Ki, and may change only one of the proportional gain Kp or the integral gain Ki. After switching between the increase operation and the decrease operation, a process such as resetting the integral term may be performed.

The gain adjustment process executed by the control adjuster 472 will now be described with reference to the flowchart of FIG. 10. Here, the control adjuster 472 changes both the proportional gain and the integral gain Kp, Ki in the same direction of increasing and decreasing.

In S23, it is determined whether the increase operation is in progress. When YES is confirmed in S23, then in S24, the control adjuster 472 sets the control gains Kp and Ki to values greater than those in the decrease operation. In S25, it is determined whether the decrease operation is in progress. When YES is confirmed in S25, then in S26, the control adjuster 472 sets the control gains Kp and Ki to values smaller than those in the increase operation.

In the second embodiment, the control gains Kp, Ki are switched in association with switching between the increase operation and the decrease operation, whereby the braking force can be appropriately controlled. The control adjuster 472 may switch either the proportional gain Kp or the integral gain Ki depending on the operations as described above. At this time, the other gain may be fixed or may be changed in the opposite direction.

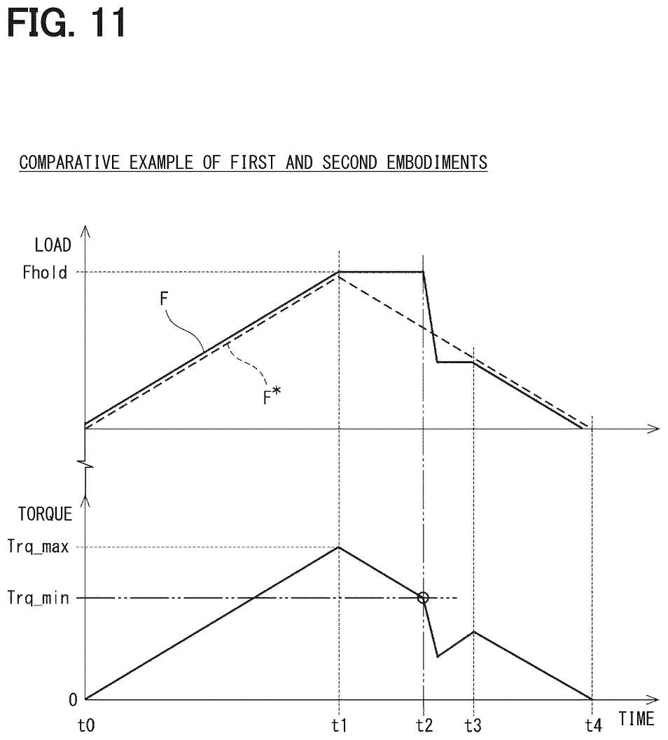

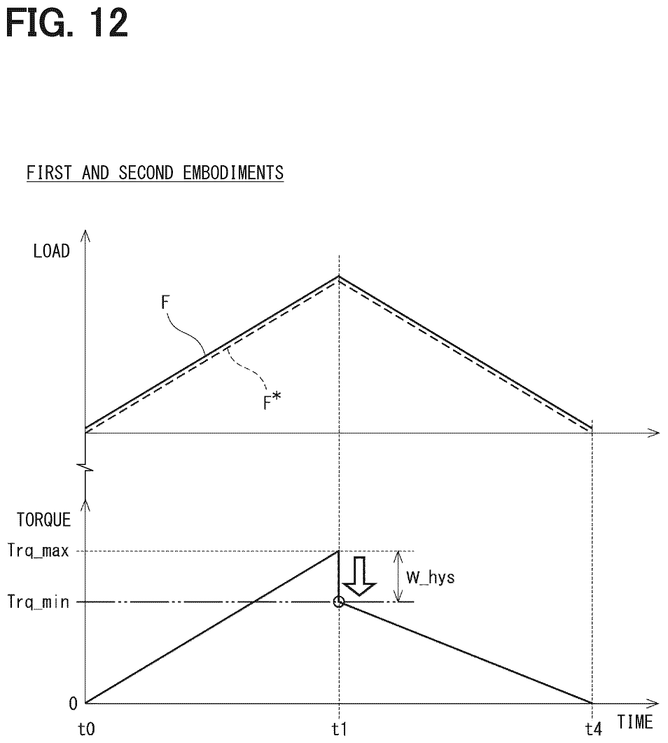

Next, with reference to FIG. 11 and FIG. 12, the effects of the combined embodiment of the first and second embodiments will be described in comparison with a comparative example. In the comparative example shown in FIG. 11, the feedforward term Trq*−FF and the control gains Kp and Ki are not adjusted. The upper part of each figure shows the changes in the load command value F* (dashed line) and the actual load F (solid line), and the lower part shows the changes in torque.

The load command value F* increases from time t0 to time t1, and then decreases from time t1 to time t4. In the period up to time t1, the actual load F increases along the positive efficiency line to the target held load Fhold following the load command value F*, and the torque increases to the maximum torque Trq_max. In the comparative example, from time t1 to time t2, the actual load F is held at the target held load Fhold while the torque is reduced by the hold operation. From the viewpoint of the responsiveness of the load F, a response delay of the actual load F to the decrease in the load command value F* occurs during this period.

When the torque decreases to the minimum torque Trq_min at time t2, the hold operation ends, and the actual load F rapidly decreases to the load command value F*. At this time, when the control gain is set large to the same extent as during the increase operation in an attempt to reduce the response delay during the decrease operation, an overshoot of the actual torque is likely to occur when switching to the decrease operation, and at the same time, the actual load F also overshoots. Thereafter, the actual torque recovers, and at time t3, when the decreased load command value F* coincides with the actual load F, the actual load F follows the load command value F* and decreases along the inverse efficiency line.

In the combined embodiment of the first and second embodiments shown in FIG. 12, at time t1 when the torque reaches the maximum torque Trq_max, the feedforward term Trq*_FF decreases by the hysteresis width W_hys with the transition from the increase operation to the decrease operation. Then, the torque instantly drops to the minimum torque Trq_min. In other words, since the operating point instantly moves from the positive efficiency line to the inverse efficiency line, no response delay occurs due to the hold operation of the braking force.

In the combined embodiment, it is possible to set separate control gains Kp, Ki for the increase and decrease operations. Therefore, by making the control gains Kp and Ki in the decrease operation smaller than the values in the increase operation, the overshoot at the time of switching to the decrease operation is suppressed. Therefore, it is possible to appropriately achieve both controllability and responsiveness.

### Third Embodiment

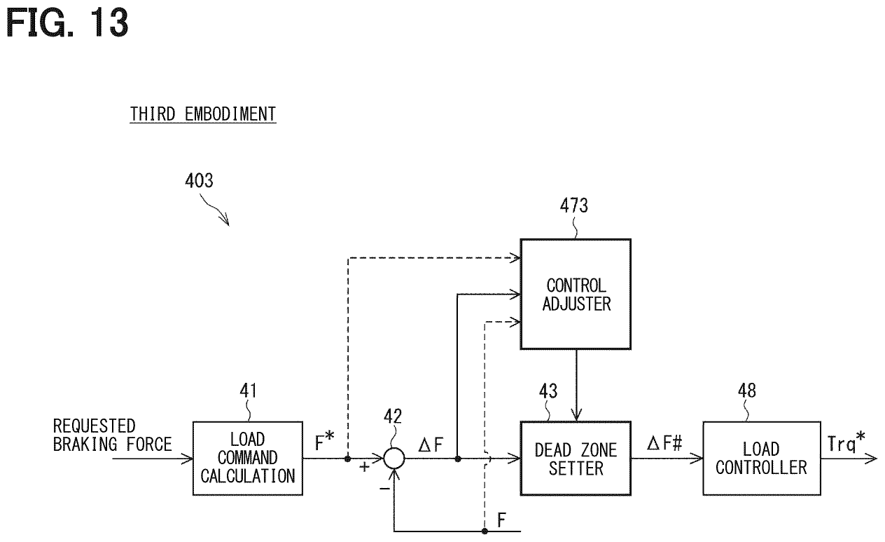

A third embodiment will be described with reference to FIGS. 13 to 18. As shown in FIG. 13, a torque command calculation unit 403 of the third embodiment has a dead zone setter 43 and a control adjuster 473 in addition to the load command calculation unit 41, the load deviation calculator 42, and the load controller 48.

The dead zone setter 43 is provided between the load deviation calculator 42 and the load controller 48. The dead zone setter 43 sets a predetermined range as a dead zone so that when the load deviation ΔF input to the load controller 48 is within a predetermined range including zero, the load deviation ΔF is regarded as zero. The dead zone setter 43 outputs the processed load deviation ΔF #to the load controller 48.

The control adjuster 473 acquires the load deviation ΔF and estimates the direction of increasing and decreasing in the braking force based on the positive and negative state of the load deviation ΔF. That is, the control adjuster 473 determines whether the current operation is the increase operation, the decrease operation, or the hold operation. Furthermore, the control adjuster 473 may obtain at least one of the load command value F* and the actual load F, as indicated by the dashed line, and calculate the other by adding or subtracting the load deviation ΔF. The control adjuster 473 may estimate the current operating point on the map based on the actual load F. An example of control using the load command value F* will be described later.

Here, the definition of the sign of the load deviation ΔF in the present embodiment will be confirmed again. In the present embodiment, the load deviation ΔF is defined as a value obtained by subtracting the actual load F from the load command value F*. In the increase operation, when the load deviation ΔF is positive, it means that the actual load F has not reached the load command value F*, and when the load deviation ΔF is negative, it means that the actual load F has exceeded the load command value F*. In the decrease operation, the opposite is true.

In the following description, the above definition of the sign of the load deviation ΔF is used as a premise. However, in other embodiments, the sign of the load deviation ΔF may be defined as being positive or negative, and in that case, the following description will be interpreted with the positive and negative signs reversed as appropriate.

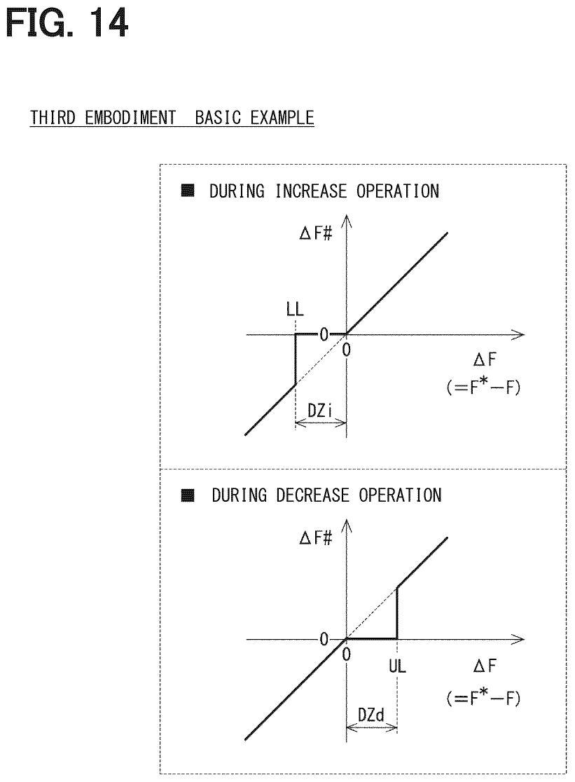

The control adjuster 473 varies the dead zone between the increase operation and the decrease operation. FIG. 14 shows the dead zone setting according to the basic example of the third embodiment. In the increase operation, the control adjuster 473 sets a dead zone DZi whose upper limit value is zero only in the negative region of the load deviation ΔF. When the actual load F increases and reaches the load command value F* and then exceeds the load command value F*, the load deviation ΔF changes from positive to negative. Then, a control is put into operation to reduce the negative load deviation ΔF to zero, and the operation is switched to the decrease operation. Therefore, by setting the dead zone DZi with a lower limit value LL in the negative region of the load deviation ΔF, even if the actual load F exceeds the load command value F*, switching to the decrease operation is prevented within the range of the dead zone DZi. Furthermore, since no dead zone DZi is provided in the positive region of the load deviation ΔF, the increase operation can be maintained with high precision until the moment when the actual load F reaches the load command value F*.

Furthermore, in the decrease operation, the control adjuster 473 sets a dead zone DZd whose lower limit value is zero only in the positive region of the load deviation ΔF. When the actual load F decreases and reaches the load command value F*, and then falls below the load command value F*, the load deviation ΔF changes from negative to positive. Then, a control is put into operation to reduce the positive load deviation ΔF to zero, and the operation is switched to the increase operation. Therefore, by setting the dead zone DZd with an upper limit value UL in the positive region of the load deviation ΔF, even if the actual load F falls below the load command value F*, switching to the increase operation is prevented within the range of the dead zone DZd. Furthermore, since no dead zone DZd is provided in the negative region of the load deviation ΔF, the decrease operation can be maintained with high accuracy until the moment when the actual load F reaches the load command value F*.

In the basic embodiment, by combining the negative dead zone DZi during the increase operation and the positive dead zone DZd during the decrease operation, frequent switching between the increase operation and the decrease operations is prevented within a specified range where the actual load F crosses the load command value F*.

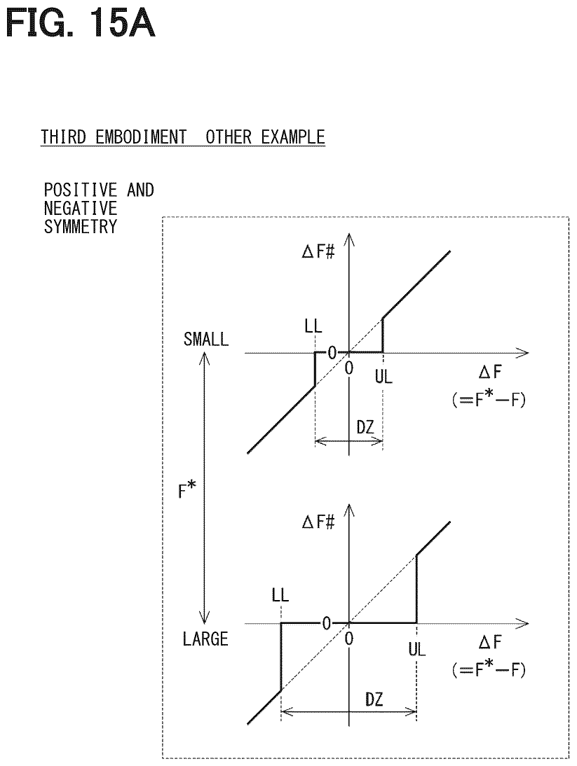

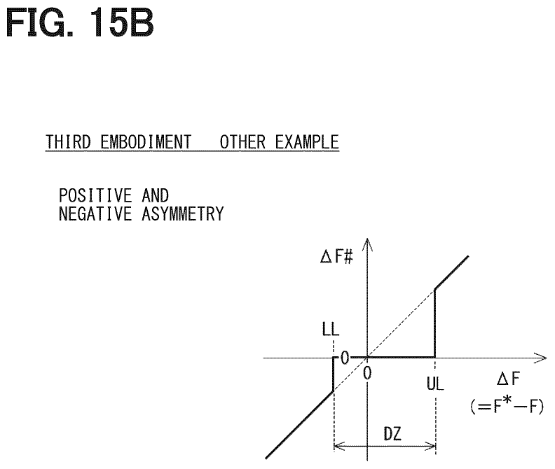

FIGS. 15A and 15B show dead zone settings according to another example of the third embodiment. In the example shown in FIG. 15A, the dead zone DZ is set symmetrically across zero, that is, so that the absolute values of the upper limit value and lower limit value are equal (|UL|=|LL|). In the example shown in FIG. 15B, the dead zone DZ is set asymmetrically across zero, that is, so that the absolute values of the upper limit value and lower limit value are different (|UL|≠|LL|).

As shown in FIG. 15A, the control adjuster 473 may set the width of the dead zone DZ to be larger as the load command value F* increases. It is possible to appropriately set the width of the dead zone DZ depending on the magnitude of the required braking force, for example so that the ratio of the dead zone DZ to the load command value F* is approximately constant. This also applies to the setting of the upper limit value and lower limit value of the dead zone provided in either the positive or negative region. In other words, the control adjuster 473 may set the absolute value of the upper limit value UL or the lower limit value LL of the dead zone to a larger value as the load command value F* increases.

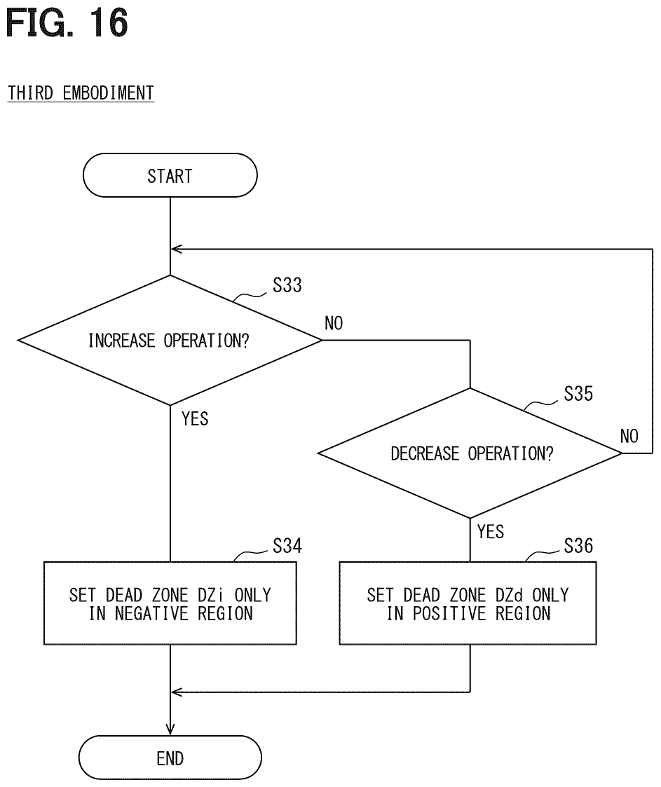

The dead zone adjustment process executed by the control adjuster 473 will be described with reference to the flowchart of FIG. 16. Here, in the basic embodiment shown in FIG. 14, an example is assumed in which the dead zone is set only in either the negative region or the positive region of the load deviation ΔF in response to the increase operation or the decrease operation.

In S33, it is determined whether the increase operation is in progress. When the answer is YES in S33, the control adjuster 473 sets the dead zone DZi only in the negative region of the load deviation ΔF in S34. In S35, it is determined whether the decrease operation is in progress. When the answer is YES in S35, the control adjuster 473 sets the dead zone DZd only in the positive region of the load deviation ΔF in S36.

In the third embodiment, the dead zone is switched in association with switching between the increase operation and the decrease operation, thereby making it possible to prevent unnecessary switching between the increase operation and the decrease operation.

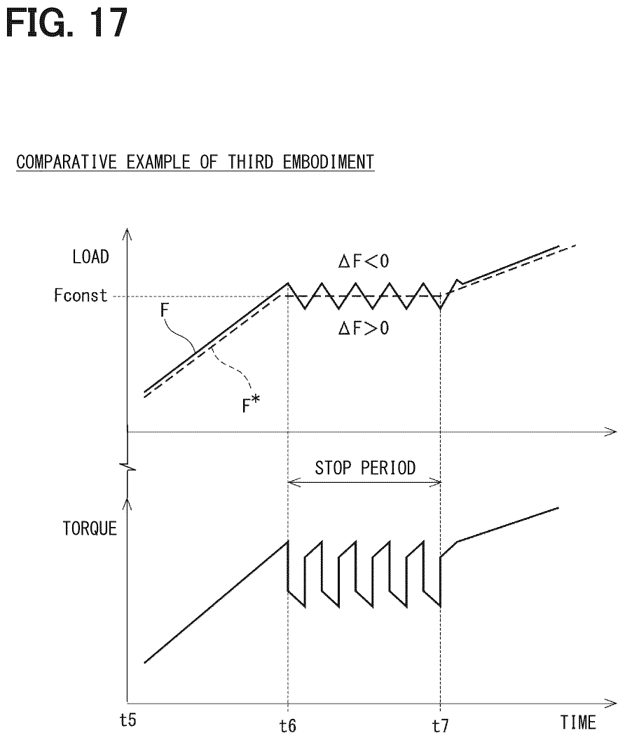

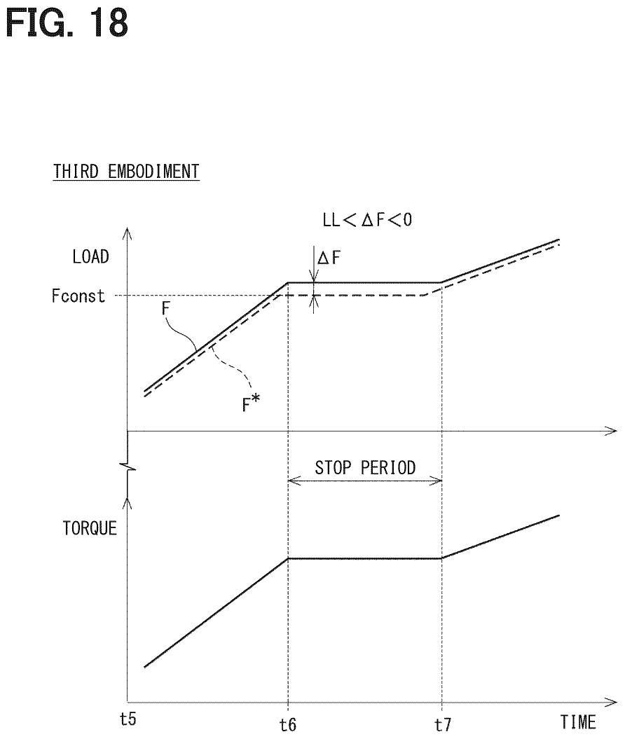

Next, with reference to FIG. 17 and FIG. 18, the effects of the third embodiment will be described in comparison with a comparative example. In the comparative example shown in FIG. 17, no dead zone is set. The upper part of each figure shows the changes in the load command value F* (dashed line) and the actual load F (solid line), and the lower part shows the changes in torque.

The load command value F* increases from time t5 to time t6, is then maintained at a constant value Fconst during the stop period from time t6 to time t7, and begins to increase again from time t7. In the comparative example, during the stop period, the actual load F tries to follow the load command value F*, and switching is performed between the increase operation and the decrease operation each time the actual load F exceeds the load command value F*. Accordingly, the torque repeatedly increases and decreases across the hysteresis width W_hys. Even if the absolute value |ΔF| of the load deviation is minute, a large change in the torque command value Trq* occurs as a periodic pulsation, which may increase the load on the load controller 48 or cause sound or electromagnetic noise.

In the third embodiment shown in FIG. 18, the dead zone DZi of the negative region is set during the increase operation, so that when the load deviation ΔF during the stop period is greater than the lower limit value LL, switching to the decrease operation is prevented. Similarly, since the dead zone DZd in the positive region is set during the decrease operation, when the load deviation ΔF during the stop period is smaller than the upper limit value UL, switching to the increase operation is prevented. Therefore, it is possible to suppress the pulsation of the torque command value Trq* when the load deviation ΔF is within the range from the lower limit value LL to the upper limit value UL.

### Fourth Embodiment

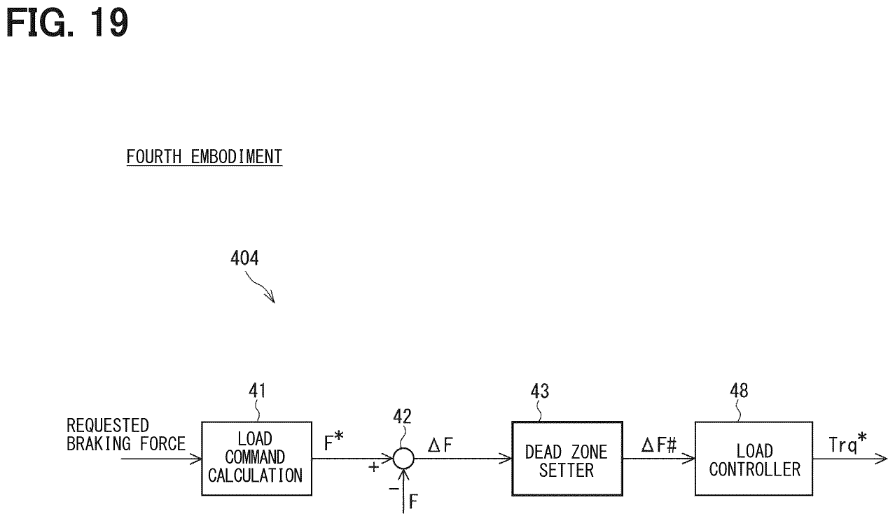

A fourth embodiment will be described with reference to FIG. 19. The torque command calculation unit 404 of the fourth embodiment has a dead zone setter 43 in addition to the load command calculation unit 41, the load deviation calculator 42, and the load controller 48, as in the third embodiment. However, in the fourth embodiment, the upper and lower limits and width of the dead zone are fixed regardless of the direction of operation or the magnitude of the load command value F*. The upper and lower limit values may be set symmetrically in the positive region and negative region, or asymmetrically in the positive region and negative region.

In the fourth embodiment, by setting the dead zone, it is possible to prevent unnecessary switching between the increase operation and the decrease operation.

### Other Embodiments

The vehicle on which the vehicle brake device of the present disclosure is mounted is not limited to a four-wheel vehicle having two rows of left and right wheels in the vehicle front-rear direction, and may be a vehicle having six or more wheels having three or more rows of wheels in the vehicle front-rear direction.

In the torque command calculation unit of the above embodiments, the load controller 48 serving as a “specific controller” calculates the torque command value Trq* so as to bring the actual load F detected by the load sensor 71 closer to the load command value F*. In a torque command calculation unit of another embodiment, a position controller serving as a “specific controller” may calculate the torque command value Trq* so as to bring the actual positions θ, X detected by the position sensors 72, 73 closer to the position command value. In this case, the braking force correlates with the positions θ and X, and the positions θ and X are used as the vertical axes of the hysteresis diagrams corresponding to FIG. 4, FIG. 6, etc. Furthermore, the “load command value” and the “actual load” in the above embodiments are interpreted as a “position command value” and an “actual position”. The deviation between the position command value and the actual position is the “position deviation.”

In the third embodiment, the position deviation is defined as a value obtained by subtracting the actual position from the position command value. The dead zone setter sets a predetermined range as a dead zone so that when the position deviation input to the position controller is within the predetermined range including zero, the position deviation is regarded as zero. In the basic example of the third embodiment, the control adjuster sets the dead zone DZi only in the negative region of the position deviation during the increase operation, and sets the dead zone DZd only in the positive region of the position deviation during the decrease operation. A configuration in which the load control and the position control are combined may be adopted.

The present disclosure should not be limited to the embodiment described above. Various other embodiments may be implemented without departing from the scope of the present disclosure.

The braking force controller and method described in the present disclosure may be implemented by a special purpose computer which is configured with a memory and a processor programmed to execute one or more particular functions embodied in computer programs of the memory. Alternatively, the braking force controller described in the present disclosure and the method thereof may be realized by a dedicated computer configured as a processor with one or more dedicated hardware logic circuits. Alternatively, the braking force controller and method described in the present disclosure may be realized by one or more dedicated computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium.

The present disclosure has been made in accordance with the embodiments. However, the present disclosure is not limited to such embodiments and configurations. The present disclosure also encompasses various modifications and variations within the scope of equivalents. Furthermore, various combination and formation, and other combination and formation including one, more than one or less than one element may be made in the present disclosure.

What is claimed is:

1. A brake device for a vehicle mounted on a vehicle having a plurality of electric brakes that is provided on each wheel, convert torque output by a motor into linear force by a linear motion mechanism and press corresponding wheels to generate braking force, the brake device for the vehicle, comprising:
a braking force control unit including a torque command calculation unit configured to calculate a torque command value for the motor based on a required braking force commanded from an external source, and a current command calculation unit configured to calculate a current command value for energizing the motor based on the torque command value, and that controls the braking force generated by each of the electric brakes; wherein
the electric brake includes a load sensor configured to detect an actual load which is a braking load actually applied to the wheel, or a position sensor configured to detect an actual position which is an actual rotation angle of the motor or an actual stroke of the linear motion mechanism,
a relationship between the torque of the motor and the braking force generated by the electric brake has a hysteresis characteristics in which, as the torque increases, the braking force increases along a positive efficiency line, as the torque decreases from a turning value where the torque changes from increasing to decreasing to a holding critical value, the braking force is maintained constant, and as the torque decreases from the holding critical value, the braking force decreases along an inverse efficiency line,
an operation that increases the torque of the motor and braking force along the positive efficiency line is defined as an increase operation, an operation that holds the braking force at any operating point between the positive efficiency line and the inverse efficiency line is defined as a hold operation, and an operation that decreases the torque of the motor and braking force along the inverse efficiency line is defined as a decrease operation,
the torque command calculation unit includes
a specific controller that calculates the torque command value so that the actual load detected by the load sensor approaches a load command value, or the actual position detected by the position sensor approaches a position command value, and
a control adjuster that adjusts a parameter of a control calculation of the specific controller, or a parameter of a control calculation on an input side or on output side of the specific controller during the increase operation, during the decrease operation, or during a transition between the increase operation and the decrease operation.

2. The brake device for the vehicle according to claim 1, wherein
the torque command calculation unit outputs the torque command value calculated by the specific controller and a feedforward term of the torque command value set by the control adjuster to the current command calculation unit,
the current command calculation unit calculates the current command value so that an actual torque, which is a torque actually output by the motor, approaches a sum of the torque command value and the feedforward term, and
the control adjuster decreases a value of the feedforward term upon the transition from the increase operation to the decrease operation, and increases the value of the feedforward term upon the transition from the decrease operation to the increase operation.

3. The brake device for the vehicle according to claim 2, wherein
the control adjuster
calculates a hysteresis width which is a difference between a maximum torque on the positive efficiency line and a minimum torque on the inverse efficiency line corresponding to a held braking force, and
sets an absolute value of an amount of change in the feedforward term at a time of transition between the increase operation and the decrease operation to be equal to or less than the hysteresis width.

4. The brake device for the vehicle according to claim 1, wherein
the specific controller of the torque command calculation unit calculates a torque command value by a control calculation including a proportional-integral control, and
the control adjuster varies at least one of a proportional gain or an integral gain of the specific controller in both the increase and decrease operations.

5. The brake device for the vehicle according to claim 4, wherein
the control adjuster makes at least one of the proportional gain or integral gain of the specific controller larger in the increase operation than in the decrease operation.

6. The brake device for the vehicle according to claim 1, wherein
the torque command calculation unit includes a dead zone setter configured to set a predetermined range as a dead zone so that a load deviation, or a position deviation is regarded as zero, when the load deviation, which is a deviation between the load command value and the actual load input to the specific controller, or the position deviation, which is a deviation between the position command value and the actual position, is within a predetermined range including zero, and
the control adjuster varies the dead zone between the increase operation and decrease operation.

7. The brake device for the vehicle according to claim 6, wherein
the load deviation is defined as a value obtained by subtracting the actual load from the load command value, or the position deviation is defined as a value obtained by subtracting the actual position from the position command value,
the control adjuster
sets the dead zone, an upper limit value of which is zero, only in a negative region of the load deviation or the position deviation in the increase operation, and
sets the dead zone, a lower limit value of which is zero, only in a positive region of the load deviation or the position deviation in the decrease operation.

8. The brake device for the vehicle according to claim 6, wherein
the control adjuster sets an absolute value of an upper limit value or a lower limit value of the dead zone to a larger value as the load command value or the position command value increases.

9. A brake device for a vehicle mounted on a vehicle having a plurality of electric brakes that is provided on each wheel, convert torque output by a motor into linear force by a linear motion mechanism and press corresponding wheels to generate braking force, the brake device for the vehicle, comprising:
a braking force control unit including a torque command calculation unit configured to calculate a torque command value for the motor based on a required braking force commanded from an external source, and a current command calculation unit configured to calculate a current command value for energizing the motor based on the torque command value, and that controls the braking force generated by each of the electric brakes; wherein
the electric brake includes a load sensor configured to detect an actual load which is a braking load actually applied to the wheel, or a position sensor 3) configured to detect an actual position which is an actual rotation angle of the motor or an actual stroke of the linear motion mechanism,
a relationship between the torque of the motor and the braking force generated by the electric brake has a hysteresis characteristics in which, as the torque increases, the braking force increases along a positive efficiency line, as the torque decreases from a turning value where the torque changes from increasing to decreasing to a holding critical value, the braking force is maintained constant, and as the torque decreases from the holding critical value, the braking force decreases along an inverse efficiency line,
the torque command calculation unit includes
a specific controller that calculates the torque command value so that the actual load detected by the load sensor approaches a load command value, or the actual position detected by the position sensor approaches a position command value, and
a dead zone setter that sets a predetermined range as a dead zone so that when a load deviation, which is a deviation between the load command value input to the specific controller and the actual load, or a position deviation, which is a deviation between the position command value and the actual position, is within the predetermined range including zero, the load deviation or the position deviation is regarded as zero.

10. A brake device for a vehicle mounted on a vehicle having a plurality of electric brakes that is provided on each wheel, convert torque output by a motor into linear force by a linear motion mechanism and press the corresponding wheels to generate braking force, wherein
the electric brake includes a load sensor configured to detect an actual load which is a braking load actually applied to the wheel, or a position sensor configured to detect an actual position which is an actual rotation angle of the motor or an actual stroke of the linear motion mechanism,
a relationship between the torque of the motor and the braking force generated by the electric brake has a hysteresis characteristics in which, as the torque increases, the braking force increases along a positive efficiency line, as the torque decreases from a turning value where the torque changes from increasing to decreasing to a holding critical value, the braking force is maintained constant, and as the torque decreases from the holding critical value, the braking force decreases along an inverse efficiency line, and
an operation that increases the torque of the motor and braking force along the positive efficiency line is defined as an increase operation, an operation that holds the braking force at any operating point between the positive efficiency line and the inverse efficiency line is defined as a hold operation, and an operation that decreases the torque of the motor and braking force along the inverse efficiency line is defined as a decrease operation,
the brake device for the vehicle, comprising:
a computer including a processor and a memory that stores instructions configured to, when executed by the processor, cause the processor to
calculate a torque command value for the motor based on a required braking force commanded from an external source,
calculate a current command value for energizing the motor based on the torque command value, and
control the braking force generated by each of the electric brakes,
wherein
the computer causes the processor to
calculate the torque command value so that the actual load detected by the load sensor approaches a load command value, or the actual position detected by the position sensor approaches a position command value by a specific controller, and
adjust a parameter of a control calculation of the specific controller, or a parameter of a control calculation on an input side or on output side of the specific controller during the increase operation, during the decrease operation, or during a transition between the increase operation and the decrease operation.

11. The brake device for the vehicle according to claim 10, wherein
the computer causes the processor to
output the torque command value calculated by the specific controller and a feedforward term of the torque command value,
calculate the current command value so that an actual torque, which is a torque actually output by the motor, approaches a sum of the torque command value and the feedforward term, and
decrease a value of the feedforward term upon the transition from the increase operation to the decrease operation, and increase the value of the feedforward term upon the transition from the decrease operation to the increase operation.

12. The brake device for the vehicle according to claim 11, wherein
the computer causes the processor to
calculate a hysteresis width which is a difference between a maximum torque on the positive efficiency line and a minimum torque on the inverse efficiency line corresponding to a held braking force, and
set an absolute value of an amount of change in the feedforward term at a time of transition between the increase operation and the decrease operation to be equal to or less than the hysteresis width.

13. The brake device for the vehicle according to claim 10, wherein
the computer causes the processor to
calculate a torque command value by a control calculation including a proportional-integral control, and
vary at least one of a proportional gain or an integral gain of the specific controller in both the increase and decrease operations.

14. The brake device for the vehicle according to claim 13, wherein
the computer causes the processor to
make at least one of the proportional gain or integral gain of the specific controller larger in the increase operation than in the decrease operation.

15. The brake device for the vehicle according to claim 10, wherein
the computer causes the processor to
set a predetermined range as a dead zone so that a load deviation, or a position deviation is regarded as zero, when the load deviation, which is a deviation between the load command value and the actual load input to the specific controller, or the position deviation, which is a deviation between the position command value and the actual position, is within a predetermined range including zero, and
vary the dead zone between the increase operation and decrease operation.

16. The brake device for the vehicle according to claim 15, wherein
the load deviation is defined as a value obtained by subtracting the actual load from the load command value, or the position deviation is defined as a value obtained by subtracting the actual position from the position command value,
the computer causes the processor to
set the dead zone, an upper limit value of which is zero, only in a negative region of the load deviation or the position deviation in the increase operation, and
set the dead zone, a lower limit value of which is zero, only in a positive region of the load deviation or the position deviation in the decrease operation.

17. The brake device for the vehicle according to claim 15, wherein
the computer causes the processor to
set an absolute value of an upper limit value or a lower limit value of the dead zone to a larger value as the load command value or the position command value increases.
